(19) United States
(12) Patent Application Publication
(10) Pub. No.: US 2021/0231882 A1
(43) Pub. Date: Jul. 29, 2021

(54) CONNECTOR WITH PIVOTING MAGNETIC DOOR

(71) Applicant: 3M INNOVATIVE PROPERTIES COMPANY, St. Paul, MN (US)

(72) Inventor: Michael A. Haase, St. Paul, MN (US)

(21) Appl. No.: 17/250,121

(22) PCT Filed: Jun. 25, 2019
(86) PCT No.: PCT/IB2019/055365

§ 371 Date: Dec. 1, 2020

Related U.S. Application Data
(60) Provisional application No. 62/691,995, filed on Jun. 29, 2018.

(51) Int. Cl. G02B 6/38; H01R 13/62

(52) U.S. Cl. CPC G02B 6/3849; H01R 13/6205

(57) ABSTRACT

A connector has a first magnetic member proximate an opening of the connector. A door of the connector has a gate with a peripheral shape conforming to a shape of an opening of the connector. A pivot of the door rotatably engages with the at least one pivot attachment of the housing on a pivot axis that extends across the gate. A protrusion of the door extends from the pivot axis away from the gate. The protrusion includes a second magnetic member. The first and second magnetic members cause the gate to block the opening in an unmated configuration of the connector.

### TECHNICAL FIELD

This disclosure relates generally to connector assemblies and methods related to connector assemblies.

### BACKGROUND

Connectors are available in a wide variety of configurations targeted for different applications. One challenge faced by some electrical and optical connectors is contaminants that can enter the connector and prevent good connections between the signal carriers (e.g., wires or optical fibers). Electrical connectors are more robust in some environments, e.g., can tolerate some amount of dust or other contaminants without significantly affecting the signal path. Optical connectors are more susceptible to degraded connections due to contaminants, as particulate contaminants can reduce the amount of light transmitted through the interface via scattering or absorption. High density optical connectors, which have small optical beams (e.g., on the order of 60 μm in width), may be additionally susceptible, as even small particles can substantially degrade the optical beam or interfere with optical alignment

### BRIEF SUMMARY

Embodiments are directed to a connector. In one embodiment, a connector includes a housing with an opening configured to receive part of a mating connector in a mated configuration of the connector. The housing has at least one pivot attachment proximate the opening and at least one first magnetic member proximate the opening. The connector also has at least one door having a gate with a peripheral shape conforming to a shape of the opening A pivot of the door rotatably engages with the at least one pivot attachment of the housing on a pivot axis that extends across the gate. A protrusion of the door extends from the pivot axis away from the gate. The protrusion has a second magnetic member that is magnetically attracted to the first magnetic member such that the first and second magnetic members cause the gate to block the opening in an unmated configuration of the connector.

In one configuration, the at least one door includes two doors. In such a case, the pivots of the two doors are located on opposite sides of the opening, and the housing further includes two pivot attachments that rotatably engage with the pivots of the two doors and two first magnetic members that magnetically interface with two second magnetic members. In one configuration, the at least one door is held at an acute angle to an inside wall of the housing by the part of the mating connector in the mated configuration. In such a case, in response to removal of the part of the mating connector in transition to the unmated configuration, a magnetic attraction between the first and second magnetic members may be sufficient to close the door regardless of orientation of the connector with respect to gravity.

In another configuration, a first moment of the protrusion and a second moment of the gate are balanced around the pivot axis. In such a case, the first and second moments may be sufficient to allow the door to close in response to attraction between the first and second magnetic members regardless of orientation of the connector with respect to gravity. In other configurations, at least one of the first and second magnetic members include rare earth magnets.

In another configuration, the protrusion extends from a portion of the pivot axis, and wherein the housing has a depression in a sidewall configured to receive the protrusion in the unmated configuration. In such a configuration, the protrusion may extend from a center region of the pivot axis. In other configurations, the protrusion extends along a full width of the gate. In yet another configuration, the protrusion includes a hole, and the second magnetic member is located in the hole. The hole may include a blind hole that opens away from the first magnetic member.

In another configuration, at least one pivot attachment includes two circular holes on opposing sides of the opening. The circular holes each have a gap on at least one edge, and the pivot includes two non-circular extensions from opposing ends of the door that have at least one dimension larger than the gaps. In such a configuration, the non-circular extensions may each include first and second non-circular surfaces joined by first and second arcuate surfaces and/or the first and second non-circular surfaces may be non-parallel to each other. The first and second non-circular surfaces may be tapered such that the first and second non-circular surfaces widen the gaps in the circular holes during insertion therein. The first and second non-circular surfaces may include flat surfaces.

In another embodiment, an optical connector housing includes an opening configured to receive part of a mating optical connector. A pair of pivot attachments is located on respective first and second sides of the opening. A first magnetic member is proximate a third side of the opening that joins the first and second sides. The optical connector includes at least one door. The door has a gate with a peripheral shape conforming to a shape of the opening. The door also includes first and second pivots that rotatably engage with the pair of pivot attachments on a pivot axis. A protrusion of the door extends from the pivot axis away from the gate proximate the first and second pivots. The protrusion includes a second magnetic member that is magnetically attracted to the first magnetic member such that the first and second magnetic members cause the gate to block the opening in an unmated configuration of the optical connector.

In one configuration, the at least one door includes two doors, the pivots of the two doors being located on opposite sides of the opening. In such a configuration, the housing includes two first magnetic members that magnetically interface with two second magnetic members. The at least one door may be held at an acute angle to an inside wall of the housing by the part of the mating optical connector in the mated configuration. In such a configuration, in response to removal of the part of the mating optical connector in transition to the unmated configuration, a magnetic attraction between the first and second magnetic members may be sufficient to close the door regardless of orientation of the optical connector with respect to gravity.

In another configuration, a first moment of the protrusion and a second moment of the gate are balanced around the pivot axis. The balancing of the first and second moments may be sufficient to allow the door to close in response to attraction between the first and second magnetic members regardless of orientation of the optical connector with respect to gravity.

In another configuration, at least one of the first and second magnetic members include rare earth magnets. In yet another configuration, the protrusion extends from a portion of the pivot axis, and the third side has a depression in a sidewall configured to receive the protrusion in the unmated configuration. The protrusion may extend from a center region of the pivot axis or may extend along a full width of the gate.

In one configuration, the protrusion includes a hole, the second magnetic member being located in the hole. The hole may include a blind hole that opens away from the first magnetic member.

In another configuration, the attachments include two circular holes on opposing sides of the opening. The circular holes each have a gap on at least one edge, and the first and second pivots include two non-circular extensions from opposing ends of the door that have at least one dimension larger than the gaps. The non-circular extensions may each comprise first and second non-circular surfaces joined by first and second arcuate surfaces, and the first and second non-circular surfaces may be non-parallel to each other. The first and second non-circular surfaces may be tapered such that the first and second non-circular surfaces widen the gaps in the circular holes during insertion therein. The first and second non-circular surfaces may include flat surfaces.

In one configuration, the optical connector further includes one or more ferrules configured to mate with one or more corresponding ferrules of the mating connectors. The ferrules and corresponding ferrules each include a plurality of facets that join to create a plurality of optical pathways.

In another embodiment, a method involves positioning a mating optical connector relative to an optical connector so that an internal structure of the mating optical connector is aligned with an opening in a housing of the optical connector. The mating optical connector is pushed towards the opening such that the internal structure contacts a gate portion of a door that is attached to the housing via a pivot. In response to further pushing of the mating optical connector towards the opening, the door is rotated about a pivot axis along one side of the gate via the internal structure. The rotating of the door causes a second magnetic member of the door to separate from a first magnetic member of the housing. The second magnetic member is located opposed to the gate away from the pivot axis. The mating optical connector is mated with the optical connector such that there is at least one optical pathway therebetween.

The method may further involve pulling the mating optical connector away from the opening such that a magnetic attraction between the first and second magnetic members causes the door to rotate resulting in the gate covering the opening in the housing. A first moment of the protrusion and a second moment of the gate may be balanced around the pivot axis such that the door to closes in response to the magnetic attraction between the first and second magnetic members regardless of orientation of the optical connector with respect to gravity. The at least one door may include two doors. The pivots of the two doors are located on opposite sides of the opening, and the housing has two first magnetic members that magnetically interface with two second magnetic members.

### BRIEF DESCRIPTION OF DRAWINGS

FIGS. 1, 2, and 3A are simplified cross-sectional views optical connectors in accordance with some embodiments;

FIG. 3B is a front view of a door according to an example embodiment;

FIG. 4 is a perspective view of mating connectors according to an example embodiment;

FIGS. 5 and 6 are close-up, perspective views of a connector door according to an example embodiment;

FIG. 7 is a diagram illustrating distribution of mass for a pivoting door according to an example embodiment;

FIG. 8 is a cross sectional view showing magnetic members of a door according to an example embodiment;

FIG. 9 is a cross sectional view showing magnetic members of a door according to another example embodiment;

FIGS. 10, 11, and 12 are side views showing the mating of connectors according to an example embodiment;

FIG. 13 is a perspective view of mating optical cable assemblies according to an example embodiment; and

FIG. 14 is a flowchart of a method according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION OF ILLUSTRATIVE EMBODIMENTS

Embodiments described herein involve connectors, such as electrical/optical cable subassemblies and electrical/optical connectors. For example, optical cables and connectors used in many applications may make use of one waveguide or arrays of multiple parallel waveguides (e.g., 4, 8 or 12 or more parallel waveguides). The individual waveguides are typically made of glass with a protective buffer coating, and the parallel waveguides are enclosed by a jacket. Optical cables and connectors including multiple waveguide cables and connectors are useful for connecting optical waveguides to optical waveguides or to optoelectronic components for in-line interconnects and/or printed circuit board (PCB) connections, e.g., backplane connections. While some embodiments below are described being used in optical cable applications, it will be understood the features may also be used in electrical cables, e.g., to reduce contamination between connectors in dirty environments such as manufacturing or vehicles.

Shutters doors are sometimes used on optical connectors to mitigate the effects of dust that can compromise the optics when disconnected. In some cases, only one of the mating connectors may include a shutter door, such as a connector that is hard to access and/or that may remain in an unmated state for long periods of time. One example of this is panel connectors, which may utilize shutter doors to keep dust from entering the optical coupling regions while unmated. If the panel connectors are located in a hard to reach area (e.g., back of the enclosure) a built-in shutter door may be preferable to other solutions, such as a cap or detachable dummy plug.

Shutter doors for a connector should positively and consistently open and close when in the appropriate mated or unmated states. Sometimes, springs are used to return the shutter doors to a closed position. For very small connectors, springs may be difficult to assemble, and can become less effective over time as the spring loses strength. Embodiments described herein use a specific configuration of permanent magnets to close and hold closed the shutter door. The door opens by rotating about an axis that is near one edge of the door. A magnet is attached to the shutter door on the side of the axis opposite the main part of the door. A fixed second magnet in located in the housing which supports the shutter. Attraction between the two magnets closes the shutter. The shutter is opened by the force of a connector plug being inserted.

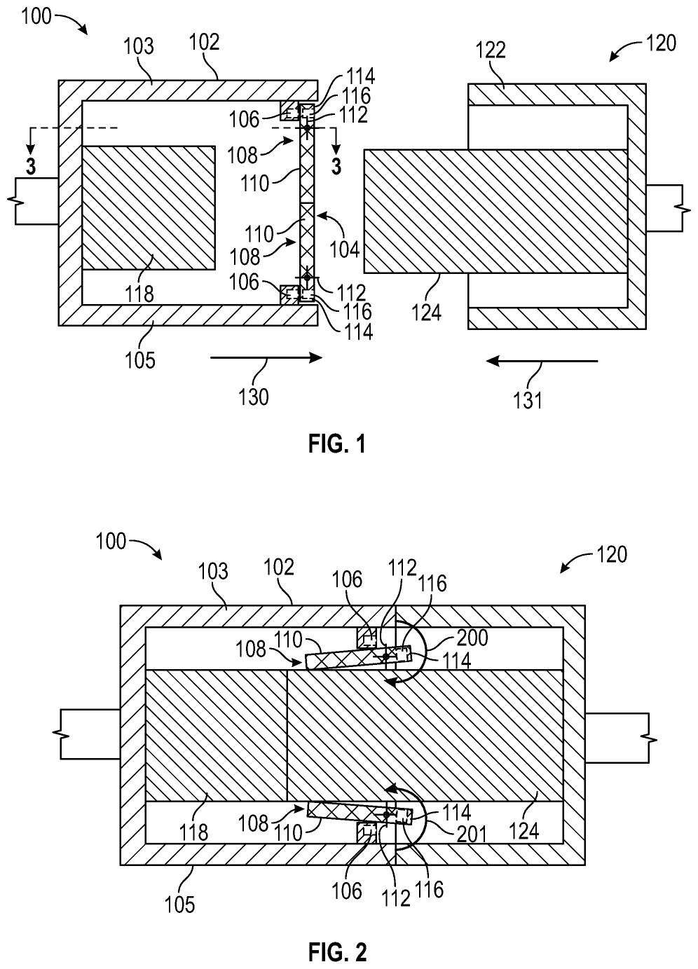

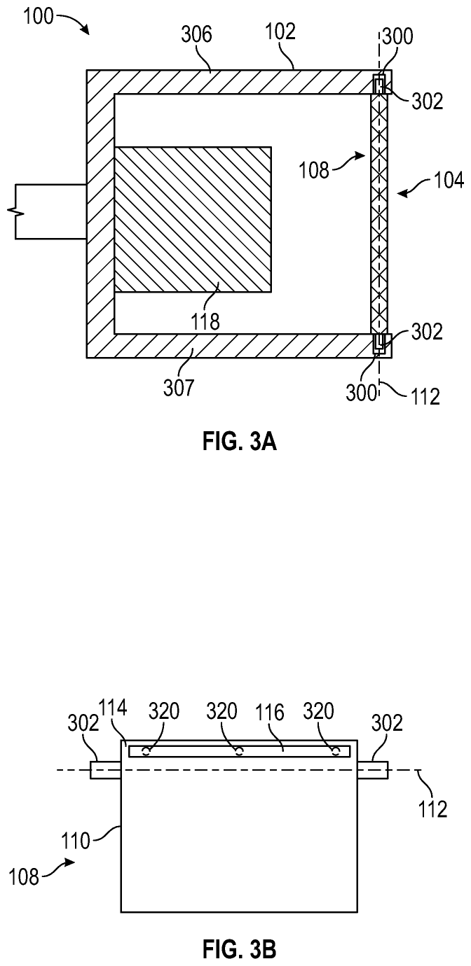

In FIGS. 1 and 2, simplified diagrams illustrate a side, cross-sectional view of a connector 100 and a mating connector 120 according to an example embodiment. A top view cross-sectional view of the connector 100 corresponding to section line 3-3 of FIG. 1 is shown in FIG. 3A. The connector 100 includes a housing 102 with an opening 104 that is configured to receive part 124 of a mating connector 120 in a mated configuration (see FIG. 2). The housing 102 includes at least one pivot attachment (see pivot attachment holes 300 in FIG. 3A) and a first magnetic member 106 proximate the opening 104. In this example, two first magnetic members 106 are shown, one for each door 108.

The connector 100 includes at least one door 108 (two doors in this example) having a gate 110. The gate 110 has a peripheral shape conforming to a shape of the opening 104, e.g., to block particles from entering inside the enclosure 102. The doors 108 each have a pivot (see pivots 302 in FIGS. 3A and 3B) that rotatably engage with the at least one pivot attachment 300 of the housing 102 on a pivot axis 112 that extends across the gate 110. A protrusion 114 extends from the pivot axis 112 away from the gate 110. The protrusion 114 has a second magnetic member 116 that is magnetically attracted to the first magnetic member 106 such that the first and second magnetic members 106, 116 cause the gate 110 to block the opening 104 in an unmated configuration of the connector 110. The magnetic members 106, 116 may include permanent magnetic with their poles aligned for attraction therebetween. In some cases, one of the magnetic members 106, 116 may be formed of a magnetic material (e.g., ferrous material) that is not permanently magnetized.

The connector enclosure includes top and bottom walls 103, 105 as seen in FIGS. 1 and 2 and sidewalls 306, 307 as shown in FIG. 3A. The mating connector 120 also includes an enclosure 122 that has walls on top, bottom, and both sides. Note that the terms “top,” “bottom,” “side,” etc., are used for convenience to reference the orientation of the illustrations. The connectors 100, 120 themselves are not necessarily limited to any particular orientation with respect to gravity, nor are the apparatuses to which the connectors 100, 120 may be attached. The connectors 100, 120 include respective internal structures 118, 124 that mate with each other to form one or more signal couplings.

As indicated by arrows 130, 131 in FIG. 1, one or both connectors 100, 120 are slid in a longitudinal direction to couple the connectors 100, 120. The internal structure 124 of the mating connector 120 pushes against gates 110, causing them to rotate as indicated by arrows 200, 201 in FIG. 2, which shows the connectors 100, 120 in the mated configuration. In the mated configuration, the doors 108 are held at an acute angle to the inside of walls 103, 105, e.g., nearly or completely parallel.

Note that in the mated configuration, the first and second magnetic members 106, 116 are separate from one another, yet still have enough magnetic attraction to close the doors 108 when the mating connector 120 is removed from the connector 100. If a first mass of the protrusion 114 (which includes the second magnetic member 116) and a second mass of the gate are sufficiently balanced around the pivot axis 112, then this magnetic attraction between the first and second magnetic members 106, 116 is sufficient to close the door 108 regardless of orientation of the connector 100 with respect to gravity. Generally, by making one or both magnetic members 106, 116 from rare earth materials (e.g., neodymium or samarium alloys), the doors 108 can be made to reliably close during un-mating yet be sufficiently easy to open during mating. Note that by making geometric changes to the gates 110 and/or the internal structure 124 of the mating connector 120 (e.g., a tapered front end of the latter), the mechanical advantage obtained when opening the doors 108 can be increased by moving the initial contact point therebetween farther from the pivot axis 112.

In FIG. 3B, a front view shows details of the door 108 according to an example embodiment. In this example, the protrusion 114 extends along a full width of the gate 110. The second magnetic member 116 also extends along most of the protrusion 114. As indicated by the dashed circles 320, one or more smaller magnetic members can be used instead. A matching number and shape of first magnetic members 106 can also be used to interface with any combinations of the second magnetic members 116, 320. Generally, the connector enclosure 102 may include a feature (e.g., channel, depression; see FIG. 1) configured to receive the protrusion such that the second magnetic member(s) 116, 302 are proximate to the first magnetic member(s) 106 thereby securing the door 108 in the closed position.

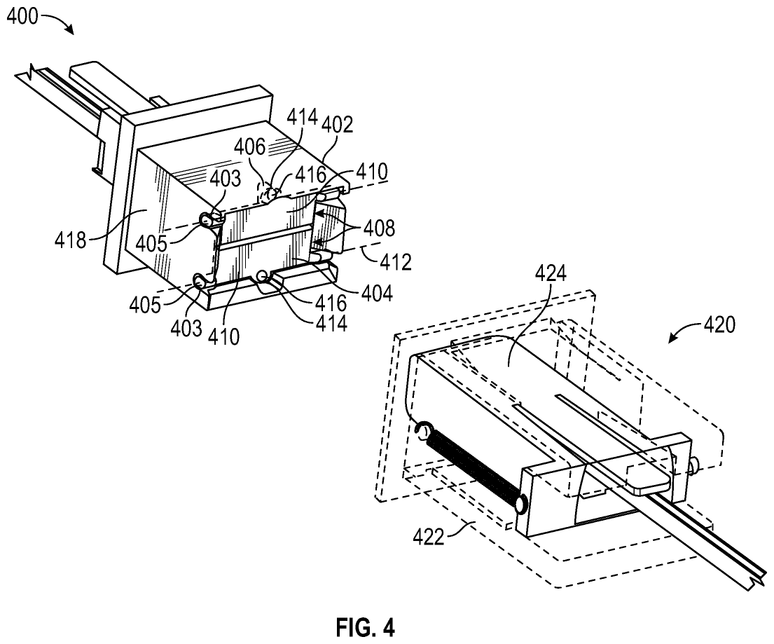

In FIG. 4, a perspective view shows an optical connector 400 and a mating optical connector 420 according to another example embodiment. The optical connector 400 includes a housing 402 with an opening 404 that is configured to receive part 424 of a mating optical connector 420 in a mated configuration. The housing 402 includes at least one pivot attachment 403 and a first magnetic member 406 proximate the opening 404. In this example, two first magnetic members 406 are shown, one for each door 408.

The connector 400 includes at least one door 408 (two doors in this example) having a gate 410. The gate 410 has a peripheral shape (rectangular in this example) conforming to a shape of the opening 404, e.g., to block particles from entering inside the enclosure 402. The doors 408 each have a pivot 405 (two pivots 405 per door 408 in this example) that rotatably engage with the at least one pivot attachment 403 of the housing 402 on a pivot axis 412 that extends across the gate 410. A protrusion 414 extends from the pivot axis 412 away from the gate 410. The protrusion 414 extends from a center region of the pivot axis 412, and has a width considerably less (e.g., around 10%) than the corresponding width of the gate 410. The protrusion 414 has a second magnetic member 416 that is magnetically attracted to the first magnetic member 406 such that the first and second magnetic members 406, 416 cause the gate 410 to block the opening 404 in an unmated configuration of the optical connector 410. As in the previous embodiments, the connectors 400, 420 include respective internal structures 418, 424 that mate with each other to form one or more optical couplings. Internal structure 424 extends outside of the enclosure 422 of the mating optical connector 420.

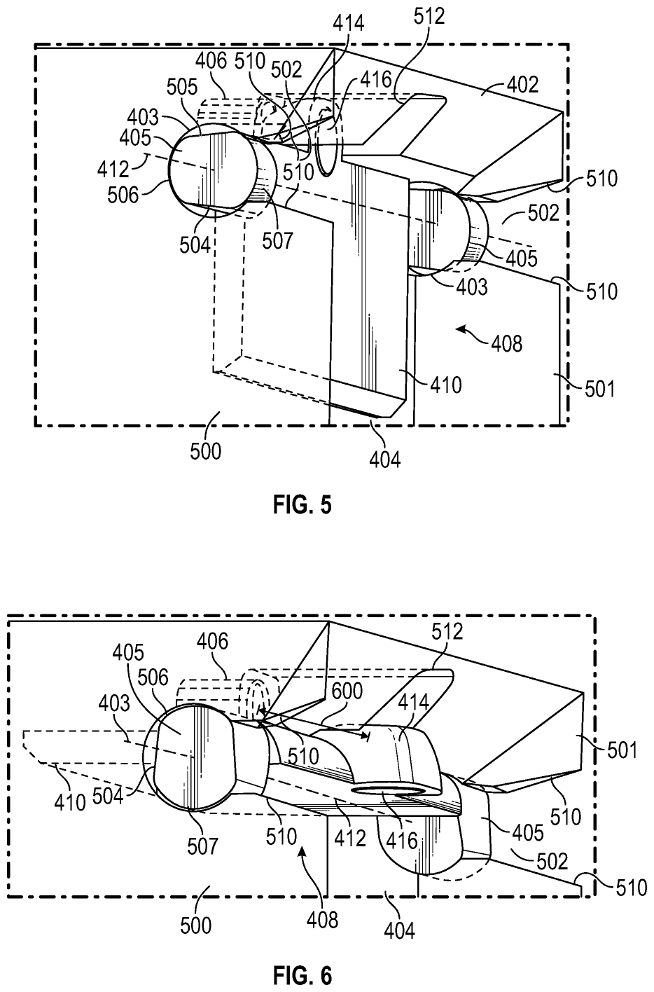

In FIGS. 5 and 6, a perspective view shows additional features of the door 408 and pivot attachments 403. The pivot attachments 403 are configured as two circular holes on opposing sides 500, 501 of the opening 404. The circular holes 403 each have a gap 502 on at least one edge. The pivots 405 include two non-circular extensions extending from opposing ends of the door 408 that are pushed through the gaps 502 of the circular holes 403 during assembly. Note that the non-circular extensions include first and second non-circular (e.g., flat) surfaces 504, 505 that are joined by arcuate surfaces 506, 507. In some embodiments, one or both of the surfaces 504, 505 may not be flat, but may have a slight convex or concave curve, for example. Also, while the pivots 405 are described as “non-circular,” parts of the pivot circumference (e.g., arcuate surfaces 506, 507) may be circular. In other embodiments, the pivots 405 may instead be fully circular (e.g., conforming to a circular shape within reasonable manufacturing tolerances).

The surfaces 504, 505 may be parallel in some embodiments, but in this example the surfaces 504, 505 are non-parallel. The non-parallel flat surfaces 504 form a taper that assists in inserting the pivots 405 into the pivot attachments 403. Arcuate surface 506 may be the same size or slightly smaller than the gap 502, while arcuate surface 507 may be larger than the gap 502. Thus the surface 506 can be inserted into the gap 502 during assembly, and the flat surfaces 504, 505 will wedge into the gap 502 causing it to elastically flex until the entire pivot 405 is inserted, after which the gap 502 will return to its original shape, trapping the pivots 405 into place. The gap 502 may include tapered surfaces 510 to assist in locating and smoothly wedging the pivots 405 into position.

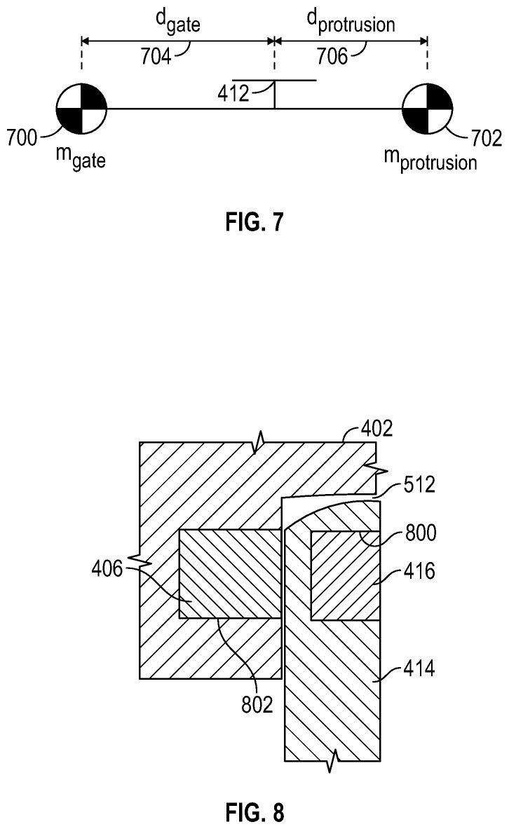

Note that the interface between the pivots 405 and the pivot attachments 403 defines the pivot axis 412. In this example the pivot axis 412 is offset from the closest outer surface plane of the gate 410. Generally, a normal projection of this axis 412 onto the gate 410 may be considered to be a demarcation between the gate 410 and the protrusion 414, as this generally defines where the moments (or torques) of the gate 410 and protrusion 414 should balance. Generally, the moments are defined by a center of mass of the gate 410 or enlarged portion 412 times a distance from the pivot axis 412 times the acceleration of gravity. By balancing these moments, gravity will not help or hinder opening and closing of the door 408. Thus the door 408 can reliably closed via the magnetic members 406, 416 regardless of orientation of the connector relative to gravity. This is illustrated schematically in FIG. 7.

The pivot axis 412 is shown in FIG. 7. The center of mass 700 of the gate 410 is shown a first distance 704 from the pivot axis 412, and the center of mass 702 of the protrusion 414 is shown a second distance 706 from the pivot axis 412. The center of mass (also sometimes referred to as the center of gravity) is a point representation of an object's mass, which is also the point upon which gravity exerts a force. The moment about the pivot axis 412 for the gate 410 can be represented by the mass 700 times the distance 704, and the moment about the pivot axis 412 for the protrusion 414 can be represented by the mass 702 times the distance 706. Because gravity is a constant and the same for both of these moments, it is omitted. Thus, using the nomenclature shown in FIG. 7, the moments are approximately balanced when m_{gate}*d_{gate}≈Mₚᵣₒₜᵣᵤₛᵢₒₙ*dₚᵣₒₜᵣᵤₛᵢₒₙ.

In reference again to FIG. 5, the enclosure 402 includes a depression 512 configured to receive at least part of the protrusion 414 in the unmated configuration. In the unmated configuration with the door closed, the attraction between the first and second magnetic members 406, 416 is at a maximum due to their close proximity. As seen in FIG. 6, the door 408 is open, corresponding to the mated configuration of the connector 400. While the distance 600 between the first and second magnetic members 406, 416 is larger in this configuration, the attraction is still strong enough to pull the protrusion 414 back towards the first magnetic member 106, which will close the door if nothing else is blocking rotation, e.g., the mating connector 420 is removed.

In FIG. 8, a cross sectional view shows details of the attachment of the second magnetic member 416 to the protrusion 414. While the second magnetic member 416 may be surface bonded or attached to a thru-hole in the protrusion 414, in this example the second magnetic member 416 is mounted in a blind hole 800 in the protrusion 414. The blind hole 800 opens away from the first magnetic member 406 in the housing. In this way, the attraction forces between the first and second magnetic members 406, 416 will not pull the second magnetic member 416 out of the protrusion 414.

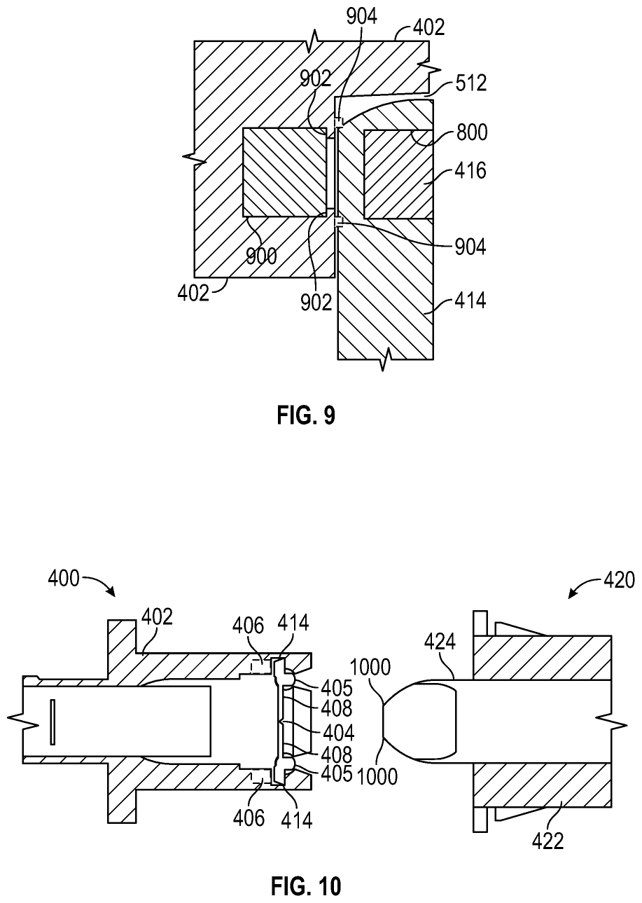

Note that the first magnetic member 406 may also be mounted in a blind hole (not shown) that opens away from the second magnetic member 406. In the illustrated configuration, the first magnetic member 406 is mounted in a blind hole 802 that opens towards the second magnetic member 406 for ease of assembly. The hole 802 may be made large enough that significant bonding material can prevent the first magnetic member 802 from being pulled out. In other embodiments, the enclosure may include additional mechanical features that affix the first magnetic member 406 into the enclosure 402. For example, as seen in FIG. 9, a blind hole 900 (which could also be configured as a thru-hole) has one or more flanges 902 that extend inward from some or all of the perimeter of the hole 900. The flanges 902 may be formed, for example, by deforming a region near the outside edge of the hole 900 after inserting and bonding the first magnetic member 406. The material for the flanges 902 may be molded onto the enclosure, as indicated by dashed boxes 904. Some plastics may be deformed this way using chemicals or heat. In other embodiments, the material that forms the flange may be mechanically added, e.g., through ultrasonic welding.

In FIGS. 10-12, side views show how the optical connector 400 and mating connector 420 are coupled according to an example embodiment. In FIG. 10, the connectors 400, 420 are in an unmated configuration but aligned such that the internal structure 424 of the mating connector 420 can be slid into the opening 404 of the optical connector 400. The doors 408 are closed and held in this position via magnetic attraction between the first magnetic member 406 and second magnetic member 416. Note that the second magnetic member 416 is not visible in FIGS. 10-12, as it is enclosed in the protrusion 416; see e.g., FIG. 4. Also note that the internal structure 424 of the mating connector has a taper such that contact regions 1000 will contact a region of the doors 408 away from the pivots 405.

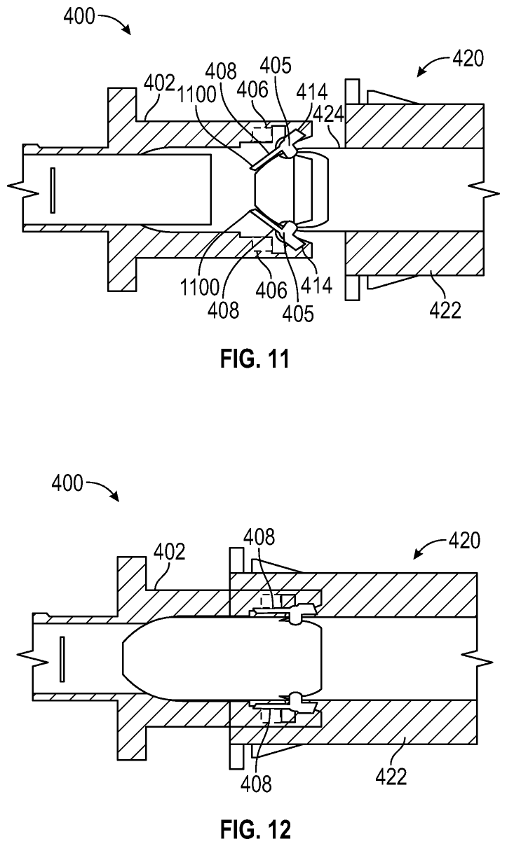

In FIG. 11, the mating connector 420 is partially inserted into the optical connector 400 such that the doors are partially opened. The magnetic attraction between first and second magnetic members 406, 416 causes the doors to ride against the internal structure 424 of the mating connector 420. Note that the doors 408 include tapers 1100 on the gate portions that allow the doors 408 to close without interfering with each other. In FIG. 12, the optical connector 400 and mating connector 420 are in the mated configuration. The doors 408 are nearly parallel to sidewalls of the enclosure 402 in this configuration.

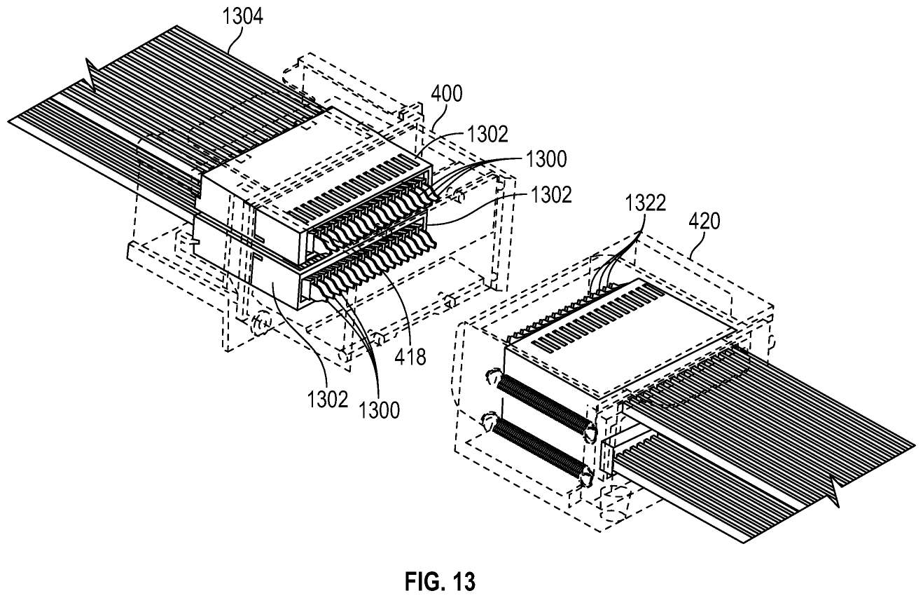

In FIG. 13, a perspective view shows optical cable assemblies 1300, 1320 according to another example embodiment that utilize the optical connector 1301 and mating connector 1321. As seen in this example, the internal structure 1318 of the optical connector 1301 includes a plurality of optical ferrules 1303 arranged within cassettes 1302. Each ferrule 1303 includes an array of mirror lenses and is coupled to an array 1304 of fibers, e.g., each array 1304 resembling a ribbon-cable. The bundled arrays 1304 exit a back end of the connector 1301. The mating connector 1301 includes a matching set of ferrules 1322 that interface with ferrules 1303 such that the respective facets join to create a plurality of optical pathways. As noted above, the connector 1301 and mating connector 1321 may be used for electrical connections (e.g., metal-to-metal contacts) instead of or in addition to the illustrated optical connections.

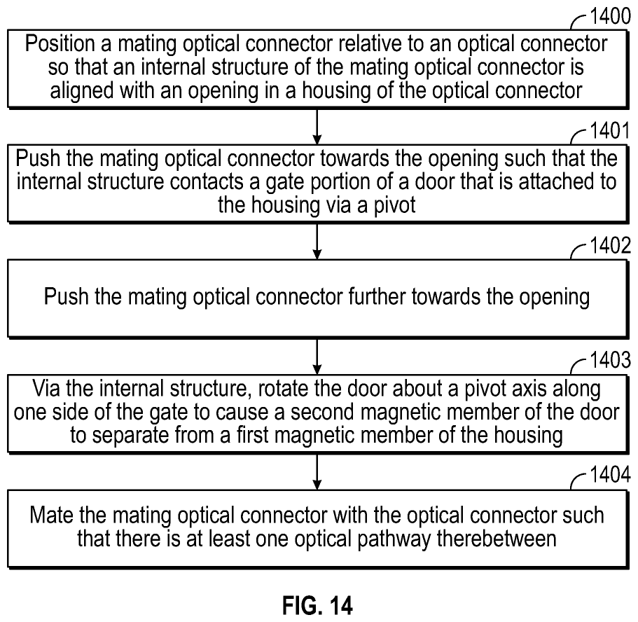

In FIG. 14, a flowchart shows a method according to an example embodiment. The method involves positioning 1400 a mating optical connector relative to an optical connector so that an internal structure of the mating optical connector is aligned with an opening in a housing of the optical connector. The mating optical connector is pushed 1401 towards the opening such that the internal structure contacts a gate portion of a door that is attached to the housing via a pivot. In response to the pushing 1402 of the mating optical connector further towards the opening, the internal structure rotates 1403 the door about a pivot axis along one side of the gate and causes a second magnetic member of the door to separate from a first magnetic member of the housing. The second magnetic member is located opposed to the gate away from the pivot axis. The mating optical connector is then mated 1404 with the optical connector such that there is at least one optical pathway therebetween.

Additional information regarding connectors that may be used in conjunction with the approaches described herein is provided in the following commonly owned and concurrently filed U.S. patent applications which are incorporated herein by reference: U.S. patent application Ser. No.______having the title “Connector with Latching Mechanism” and identified by Attorney Docket Number 76663US002; U.S. patent application Ser. No.______, having the title “Ferrules, Alignment Frames and Connectors,” and identified by Attorney Docket Number 75767US002; U.S. patent application Ser. No.______, having the title “Optical Cable Assembly with Retainer,” identified by Attorney Docket Number 76662US002; U.S. patent application Ser. No.______, having the title “Dust Mitigating Optical Connector,” identified by Attorney Docket Number 76664US002; U.S. patent application______, having the title “Configurable Modular Connectors,” identified by Attorney Docket Number 75907US002; and U.S. patent application______, having the title “Hybrid Connectors,” identified by Attorney Docket Number 76908US002.

Embodiments described in this disclosure include:
Item 1. A connector, comprising:
a housing with an opening configured to receive part of a mating connector in a mated configuration of the connector, the housing comprising at least one pivot attachment proximate the opening and at least one first magnetic member proximate the opening; and
at least one door comprising:
a gate with a peripheral shape conforming to a shape of the opening;
a pivot that rotatably engages with the at least one pivot attachment of the housing on a pivot axis that extends across the gate; and
a protrusion extending from the pivot axis away from the gate, the protrusion comprising a second magnetic member that is magnetically attracted to the first magnetic member such that the first and second magnetic members cause the gate to block the opening in an unmated configuration of the connector.
   Item 2. The connector of item 1, wherein the at least one door comprises two doors, the pivots of the two doors being located on opposite sides of the opening, and wherein the housing comprises two pivot attachments that rotatably engage with the pivots of the two doors and two first magnetic members that magnetically interface with two second magnetic members.
   Item 3. The connector of any of items 1-2, wherein the at least one door is held at an acute angle to an inside wall of the housing by the part of the mating connector in the mated configuration.
   Item 4. The connector of item 3, wherein, in response to removal of the part of the mating connector in transition to the unmated configuration, a magnetic attraction between the first and second magnetic members is sufficient to close the door regardless of orientation of the connector with respect to gravity.
   Item 5. The connector of any of items 1-4, wherein a first moment of the protrusion and a second moment of the gate are balanced around the pivot axis.
   Item 6. The connector of item 5, wherein the balancing of the first and second moments are sufficient to allow the door to close in response to attraction between the first and second magnetic members regardless of orientation of the connector with respect to gravity.
   Item 7. The connector of any of items 1-6, wherein at least one of the first and second magnetic members comprise rare earth magnets.
   Item 8. The connector of any of items 1-7, wherein the protrusion extends from a portion of the pivot axis, and wherein the housing has a depression in a sidewall configured to receive the protrusion in the unmated configuration.
   Item 9. The connector of item 8, wherein the protrusion extends from a center region of the pivot axis.
   Item 10. The connector of item any of items 1-8, wherein the protrusion extends along a full width of the gate.
   Item 11. The connector of any of items 1-10, wherein the protrusion comprises a hole, the second magnetic member located in the hole.
   Item 12. The connector of item 11, wherein the hole comprises a blind hole that opens away from the first magnetic member.
   Item 13. The connector of item any of items 1-11, wherein the at least one pivot attachment comprises two circular holes on opposing sides of the opening, the circular holes each having a gap on at least one edge, and wherein the pivot comprises two non-circular extensions from opposing ends of the door that have at least one dimension larger than the gaps.
   Item 14. The connector of item 13, wherein the non-circular extensions each comprise first and second non-circular surfaces joined by first and second arcuate surfaces.
   Item 15. The connector of item 14, wherein the first and second non-circular surfaces are non-parallel to each other.
   Item 16. The connector of item any of items 14-15, wherein the first and second non-circular surfaces are tapered such that the first and second non-circular surfaces widen the gaps in the circular holes during insertion therein.
   Item 17. The connector of any of items 14-16, wherein the first and second non-circular surfaces comprise flat surfaces.
   Item 18. An optical connector housing, comprising:
an opening configured to receive part of a mating optical connector;
a pair of pivot attachments on respective first and second sides of the opening;
a first magnetic member proximate a third side of the opening that joins the first and second sides; and
at least one door, comprising:
a gate with a peripheral shape conforming to a shape of the opening;
first and second pivots that rotatably engage with the pair of pivot attachments on a pivot axis; and
a protrusion extending from the pivot axis away from the gate proximate the first and second pivots, the protrusion comprising a second magnetic member that is magnetically attracted to the first magnetic member such that the first and second magnetic members cause the gate to block the opening in an unmated configuration of the optical connector.
   Item 19. The optical connector of item 18, wherein the at least one door comprises two doors, the pivots of the two doors being located on opposite sides of the opening, and wherein the housing comprises two first magnetic members that magnetically interface with two second magnetic members.
   Item 20. The optical connector of any of items 18-19, wherein the at least one door is held at an acute angle to an inside wall of the housing by the part of the mating optical connector in the mated configuration.
   Item 21. The optical connector of item 20, wherein, in response to removal of the part of the mating optical connector in transition to the unmated configuration, a magnetic attraction between the first and second magnetic members is sufficient to close the door regardless of orientation of the optical connector with respect to gravity.
   Item 22. The optical connector of item any of items 18-21, wherein a first moment of the protrusion and a second moment of the gate are balanced around the pivot axis.
   Item 23. The optical connector of item 22, wherein the balancing of the first and second moments are sufficient to allow the door to close in response to attraction between the first and second magnetic members regardless of orientation of the optical connector with respect to gravity.
   Item 24. The optical connector of item any of items 18-23, wherein at least one of the first and second magnetic members comprise rare earth magnets.
   Item 25. The optical connector of any of items 18-24, wherein the protrusion extends from a portion of the pivot axis, and wherein the third side has a depression in a sidewall configured to receive the protrusion in the unmated configuration.
   Item 26. The optical connector of item 25, wherein the protrusion extends from a center region of the pivot axis.
   Item 27. The optical connector of item any of items 18-25, wherein the protrusion extends along a full width of the gate.
   Item 28. The optical connector of any of items 18-27, wherein the protrusion comprises a hole, the second magnetic member located in the hole.
   Item 29. The optical connector of item 28, wherein the hole comprises a blind hole that opens away from the first magnetic member.
   Item 30. The optical connector of item any of items 18-29, wherein the attachments comprises two circular holes on opposing sides of the opening, the circular holes each having a gap on at least one edge, and wherein the first and second pivots comprises two non-circular extensions from opposing ends of the door that have at least one dimension larger than the gaps.
   Item 31. The optical connector of item 30, wherein the non-circular extensions each comprise first and second non-circular surfaces joined by first and second arcuate surfaces.
   Item 32. The optical connector of item 31, wherein the first and second non-circular surfaces are non-parallel to each other.
   Item 33. The optical connector any of items 31-32, wherein the first and second non-circular surfaces are tapered such that the first and second non-circular surfaces widen the gaps in the circular holes during insertion therein.
   Item 34. The optical connector of any of items 31-33, wherein the first and second non-circular surfaces comprise flat surfaces.
   Item 35. The optical connector of item any of items 18-34, further comprising one or more ferrules configured to mate with one or more corresponding ferrules of the mating connectors, the ferrules and corresponding ferrules each comprising a plurality of facets that join to create a plurality of optical pathways.
   Item 36. A method, comprising:
positioning a mating optical connector relative to an optical connector so that an internal structure of the mating optical connector is aligned with an opening in a housing of the optical connector;
pushing the mating optical connector towards the opening such that the internal structure contacts a gate portion of a door that is attached to the housing via a pivot;
in response to further pushing of the mating optical connector towards the opening, rotating the door about a pivot axis along one side of the gate via the internal structure, the rotating of the door causes a second magnetic member of the door to separate from a first magnetic member of the housing, the second magnetic member being located opposed to the gate away from the pivot axis; and mating the mating optical connector with the optical connector such that there is at least one optical pathway therebetween.
   Item 37. The method of item 36, further comprising pulling the mating optical connector away from the opening, a magnetic attraction between the first and second magnetic members causes the door to rotate such that the gate covers the opening in the housing.
   Item 38. The method of item 37, wherein a first moment of the protrusion and a second moment of the gate are balanced around the pivot axis such that the door to closes in response to the magnetic attraction between the first and second magnetic members regardless of orientation of the optical connector with respect to gravity.
   Item 39. The method any of items 36-38, wherein the at least one door comprises two doors, the pivots of the two doors being located on opposite sides of the opening, and wherein the housing comprises two first magnetic members that magnetically interface with two second magnetic members.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Various modifications and alterations of the embodiments discussed above will be apparent to those skilled in the art, and it should be understood that this disclosure is not limited to the illustrative embodiments set forth herein. The reader should assume that features of one disclosed embodiment can also be applied to all other disclosed embodiments unless otherwise indicated. It should also be understood that all U.S. patents, patent applications, patent application publications, and other patent and non-patent documents referred to herein are incorporated by reference, to the extent they do not contradict the foregoing disclosure.

1. A connector, comprising:
a housing with an opening configured to receive part of a mating connector in a mated configuration of the connector, the housing comprising at least one pivot attachment proximate the opening and at least one first magnetic member proximate the opening; and
at least one door comprising:
a gate with a peripheral shape conforming to a shape of the opening;
a pivot that rotatably engages with the at least one pivot attachment of the housing on a pivot axis that extends across the gate; and
a protrusion extending from the pivot axis away from the gate, the protrusion comprising a second magnetic member that is magnetically attracted to the first magnetic member such that the first and second magnetic members cause the gate to block the opening in an unmated configuration of the connector.

2. The connector of claim 1, wherein the at least one door comprises two doors, the pivots of the two doors being located on opposite sides of the opening, and wherein the housing comprises two pivot attachments that rotatably engage with the pivots of the two doors and two first magnetic members that magnetically interface with two second magnetic members.

3. The connector of claim 1, wherein the at least one door is held at an acute angle to an inside wall of the housing by the part of the mating connector in the mated configuration, and wherein, in response to removal of the part of the mating connector in transition to the unmated configuration, a magnetic attraction between the first and second magnetic members is sufficient to close the door regardless of orientation of the connector with respect to gravity.

4. An optical connector housing, comprising:
an opening configured to receive part of a mating optical connector;
a pair of pivot attachments on respective first and second sides of the opening;
a first magnetic member proximate a third side of the opening that joins the first and second sides; and
at least one door, comprising:
a gate with a peripheral shape conforming to a shape of the opening;
first and second pivots that rotatably engage with the pair of pivot attachments on a pivot axis; and
a protrusion extending from the pivot axis away from the gate proximate the first and second pivots, the protrusion comprising a second magnetic member that is magnetically attracted to the first magnetic member such that the first and second magnetic members cause the gate to block the opening in an unmated configuration of the optical connector.

5. The optical connector of claim 4, wherein a first moment of the protrusion and a second moment of the gate are balanced around the pivot axis, and wherein the balancing of the first and second moments are sufficient to allow the door to close in response to attraction between the first and second magnetic members regardless of orientation of the optical connector with respect to gravity.

6. The optical connector of claim 4, wherein the attachments comprises two circular holes on opposing sides of the opening, the circular holes each having a gap on at least one edge, wherein the first and second pivots comprises two non-circular extensions from opposing ends of the door that have at least one dimension larger than the gaps, wherein the non-circular extensions each comprise first and second non-circular surfaces joined by first and second arcuate surfaces, wherein the first and second non-circular surfaces are non-parallel to each other, wherein the first and second non-circular surfaces are tapered such that the first and second non-circular surfaces widen the gaps in the circular holes during insertion therein, and wherein the first and second non-circular surfaces comprise flat surfaces.

7. The optical connector of claim 4, further comprising one or more ferrules configured to mate with one or more corresponding ferrules of the mating connectors, the ferrules and corresponding ferrules each comprising a plurality of facets that join to create a plurality of optical pathways.

8. A method, comprising:
positioning a mating optical connector relative to an optical connector so that an internal structure of the mating optical connector is aligned with an opening in a housing of the optical connector;
pushing the mating optical connector towards the opening such that the internal structure contacts a gate portion of a door that is attached to the housing via a pivot;
in response to further pushing of the mating optical connector towards the opening, rotating the door about a pivot axis along one side of the gate via the internal structure, the rotating of the door causes a second magnetic member of the door to separate from a first magnetic member of the housing, the second magnetic member being located opposed to the gate away from the pivot axis; and
mating the mating optical connector with the optical connector such that there is at least one optical pathway therebetween.

9. The method of claim 8, further comprising pulling the mating optical connector away from the opening, a magnetic attraction between the first and second magnetic members causes the door to rotate such that the gate covers the opening in the housing, wherein a first moment of the protrusion and a second moment of the gate are balanced around the pivot axis such that the door to closes in response to the magnetic attraction between the first and second magnetic members regardless of orientation of the optical connector with respect to gravity.

10. The method of claim 8, wherein the at least one door comprises two doors, the pivots of the two doors being located on opposite sides of the opening, and wherein the housing comprises two first magnetic members that magnetically interface with two second magnetic members.

11. The connector of claim 1, wherein a first moment of the protrusion and a second moment of the gate are balanced around the pivot axis, and wherein, the balancing of the first and second moments are sufficient to allow the door to close in response to attraction between the first and second magnetic members regardless of orientation of the connector with respect to gravity.

12. The connector of claim 1, wherein the protrusion extends from a portion of the pivot axis, and wherein the housing has a depression in a sidewall configured to receive the protrusion in the unmated configuration, and wherein, the protrusion extends from a center region of the pivot axis.

13. The connector of claim 1, wherein the protrusion extends along a full width of the gate.

14. The connector of claim 1, wherein the at least one pivot attachment comprises two circular holes on opposing sides of the opening, the circular holes each having a gap on at least one edge, and wherein the pivot comprises two non-circular extensions from opposing ends of the door that have at least one dimension larger than the gaps.

15. The optical connector of claim 4, wherein the at least one door comprises two doors, the pivots of the two doors being located on opposite sides of the opening, and wherein the housing comprises two first magnetic members that magnetically interface with two second magnetic members.

16. The optical connector of claim 4, wherein the at least one door is held at an acute angle to an inside wall of the housing by the part of the mating optical connector in the mated configuration.

17. The optical connector of claim 16, wherein, in response to removal of the part of the mating optical connector in transition to the unmated configuration, a magnetic attraction between the first and second magnetic members is sufficient to close the door regardless of orientation of the optical connector with respect to gravity.

18. The optical connector of claim 4, wherein at least one of the first and second magnetic members comprise rare earth magnets.

19. The optical connector of claim 4, wherein the protrusion extends from a portion of the pivot axis, and wherein the third side has a depression in a sidewall configured to receive the protrusion in the unmated configuration.

20. The optical connector of claim 4, wherein the protrusion comprises a hole, the second magnetic member located in the hole, and wherein, the hole comprises a blind hole that opens away from the first magnetic member.
